(19) United States
(12) Patent Application Publication
(10) Pub. No.: US 2026/0005757 A1
(43) Pub. Date: Jan. 1, 2026

(54) Hitless readmittance of recovered traffic to a group supporting partial survivability

(71) Applicant: Ciena Corporation, Hanover, MD (US)

(72) Inventor: Andrew McCarthy, Stittsville (CA)

(73) Assignee: Ciena Corporation, Hanover, MD (US)

(21) Appl. No.: 18/755,565

(22) Filed: Jun. 26, 2024

(51) Int. Cl. H04B 10/03; H04Q 11/00

(52) U.S. Cl. CPC H04B 10/03; H04Q 11/0067

(57) ABSTRACT

Systems and methods for hitless readmittance of recovered traffic to a group supporting partial survivability include receiving a plurality of components, wherein each component of the plurality of components is a traffic flow having a frequency and phase of associated frame position, and wherein the plurality of components represent an aggregate signal; equalizing skew of the plurality of components; responsive to one or more failed components of the plurality of components, replacing the one or more failed components with an associated replacement signal; and, subsequent to the one or more failed components becoming one or more recovered components, hitlessly readmitting the one or more recovered components by modifying the skew until non-failed components and the one or more recovered components are phase aligned.

### FIELD OF THE DISCLOSURE

The present disclosure relates generally to networking and computing. More particularly, the present disclosure relates to systems and methods for hitless readmittance of recovered traffic to a group supporting partial survivability.

### BACKGROUND OF THE DISCLOSURE

As network demands continue to grow, some protocols are supporting larger logical signals which are groups of multiple smaller signals. For example, ITU-T Recommendation G.709 “Interfaces for the optical transport network” (June 2020), the contents of which are incorporated by reference, describe the use of multiple optical carriers for a single digital transport interface in line side applications, such as an Optical Transport Unit-Cn (OTUCn) which is carried via multiple Optical Tributary Signal (OTSi) carriers (lambdas). For client-side applications, ITU-T Recommendation G.709.1 (February 2024) defines the use of multiple client services/modules for a single OTUCn transport service, and, for long-reach applications, ITU-T Recommendation G.709.3 (March 2024) defines Flexible Optical Transport Network (FlexO) with different services multiplexed over a single optical channel. The present disclosure contemplates any of these protocols, as well as other types, and refers to these as grouped traffic protocols where the overall signal is a large rate (e.g., 400G, 800G, 1.6T, etc., such as integer values of 100G), formed by lower rate signals or components (e.g., 100G-4×100G for the 400G, 8×100G for the 800G, etc.). Of course, other values are also contemplated, e.g., the lower rate signals can be higher than 100G, such as 4×400G for 1.6T. For transport, each lower rate component can be an OTSi, and there is a potential that one or more of the OTSi fails.

### BRIEF SUMMARY OF THE DISCLOSURE

The present disclosure relates to systems and methods for hitless readmittance of recovered traffic to a group supporting partial survivability. Again, protocols, such as in OTN, etc., include managing an aggregate signal (e.g., FlexO, OTUCn, etc.) as a group of component signals (e.g., 100G tributaries). These components are all phase aligned and frequency locked. Again, partial survivability is the concept that, when one of these components fail, the remaining components in the group can continue to carry traffic without also being affected by the failure. Examples of partial survivability are described in U.S. Pat. No. 10,333,614, entitled “Partial survivability for multi-carrier and multi-module optical interfaces,” the contents of which are incorporated by reference in their entirety. This may happen for example, in a mated pair application where parts of the traffic are carried over different wavelengths or different routes and one of these links fails. The present disclosure addresses the hitless re-admitting of any partially failed component into a group on recovery.

In an embodiment, a circuit is configured to receive a plurality of components, wherein each component of the plurality of components is a traffic flow having a frequency and phase of associated frame position, and wherein the plurality of components represent an aggregate signal, equalize skew of the plurality of components, responsive to one or more failed components of the plurality of components, replace the one or more failed components with an associated replacement signal, and, subsequent to the one or more failed components becoming one or more recovered components, hitlessly readmit the one or more recovered components by modifying the skew until non-failed components and the one or more recovered components are phase aligned.

The modifying the skew can include manipulation of a clock of the non-failed components, based on a skew of the one or more recovered components, and readmission of the one or more recovered components subsequent to the manipulation. The manipulation of the clock includes slowing down a read clock used for the non-failed components, while maintaining a write clock as is.

The one or more recovered components are hitlessly readmitted after equalizing the skew of the non-failed components with a skew of the one or more recovered components. The circuit can be further configured to provide the non-failed components and the one or more recovered components, collectively second plurality of components, to a transmitter where the second plurality of components are phase and frequency aligned. The circuit can be further configured to cause transmission of the second plurality of components, by the transmitter, on one or more interfaces, wherein the second plurality of components are received from a second plurality of interfaces.

The one or more recovered components can be hitlessly readmitted based on measurement of a skew of the one or more recovered components, and manipulation of a clock based on the measurement. The one or more recovered components can be hitlessly readmitted based on the circuit configured to perform one of readmit the one or more recovered components with delay if the one or more recovered components have a frame position earlier in time than that of the non-failed components, readmit the one or more recovered components as is if the one or more recovered components have the frame position at a same time as that of the non-failed components, and perform clock manipulation of the non-failed components to equalize the skew when the one or more recovered components have the frame position later in time. The aggregate signal can be one of a Flexible Optical Transport Network (FlexO) signal and an Optical Transport Unit-Cn (OTUCn). The receiving can be via a plurality of Optical Tributary Signal (OTSi) carriers.

In another embodiment, a method includes steps of receiving a plurality of components, wherein each component of the plurality of components is a traffic flow having a frequency and phase of associated frame position, and wherein the plurality of components represent an aggregate signal; equalizing skew of the plurality of components; responsive to one or more failed components of the plurality of components, replacing the one or more failed components with an associated replacement signal; and, subsequent to the one or more failed components becoming one or more recovered components, hitlessly readmitting the one or more recovered components by modifying the skew until non-failed components and the one or more recovered components are phase aligned.

The modifying the skew can include manipulating of a clock of the non-failed components, based on a skew of the one or more recovered components, and readmitting the one or more recovered components subsequent to the manipulation. The manipulating the clock includes slowing down a read clock used for the non-failed components, while maintaining a write clock as is. The one or more recovered components can be hitlessly readmitted after equalizing the skew of the non-failed components with a skew of the one or more recovered components.

The steps can further include providing the non-failed components and the one or more recovered components, collectively second plurality of components, to a transmitter where the second plurality of components are phase and frequency aligned. The steps can further include causing transmission of the second plurality of components, by the transmitter, on one or more interfaces, wherein the second plurality of components are received from a second plurality of interfaces. The one or more recovered components can be hitlessly readmitted based on measuring a skew of the one or more recovered components, and manipulating of a clock based on the measurement.

The one or more recovered components can be hitlessly readmitted based on steps of readmitting the one or more recovered components with delay if the one or more recovered components have a frame position earlier in time than that of the non-failed components; readmitting the one or more recovered components as is if the one or more recovered components have the frame position at a same time as that of the non-failed components; and performing clock manipulation of the non-failed components to equalize the skew when the one or more recovered components have the frame position later in time. The aggregate signal can be one of a Flexible Optical Transport Network (FlexO) signal and an Optical Transport Unit-Cn (OTUCn). The receiving can be via a plurality of Optical Tributary Signal (OTSi) carriers.

### BRIEF DESCRIPTION OF THE DRAWINGS

The present disclosure is detailed through various drawings, where like components or steps are indicated by identical reference numbers for clarity and consistency.

FIG. 1 is a block diagram of a circuit for supporting hitless readmittance of recovered traffic to a group supporting partial survivability.

FIG. 2 is a flowchart of a process for hitless readmittance of recovered traffic to a group supporting partial survivability.

### DETAILED DESCRIPTION OF THE DISCLOSURE

Again, the present disclosure relates to systems and methods for hitless readmittance of recovered traffic to a group supporting partial survivability.

From a terminology perspective, the present disclosure includes an aggregate signal, which can be referred to as a logical signal, a composite signal, a higher-rate signal, a group, etc., and can include a FlexOn, OTUCn, etc., where n=1, 2, 3, . . . and determines an overall size of the aggregate signal (e.g., a FlexO8 is 800G). The aggregate signal is a signal composed of various component signals. To that end, a component signal is a lower-rate signal, relative to the aggregate signal, e.g., an OTUC1, an OTUC2, etc. For example, the aggregate signal can be an OTUC4, i.e., 400G, formed by 4 OTUC1, 2 OTUC2, etc. In a typical application, e.g., the OTUC4 can be transmitted by four different optical carriers (OTSi). Also, the components are said to be bonded to one another in the aggregate signal.

Note, the present disclosure focuses on the electrical domain processing of the aggregate signal. For example, the following describes a typical operation of partial survivability and associated recovery.
(1) There is a failure of a component in the aggregate signal, e.g., one of the OTUC1 fails such as due to an OTSi failure or the like.
(2) After which a replacement signal is provided for the failed components enabling partial survivability of the aggregate signal, where the replacement signal is substituted in the electrical domain for processing the aggregate signal, and where the replacement signal is used to maintain the current frame position (which is synonymous with phase of the traffic) and traffic rate of the failure component.
(3) When the failed component recovers, it needs to be readmitted, in place of the replacement signal. However, the frame position of the failed component relative to the other components may have changed for various reasons, such as a change of route of the traffic (e.g., the failed OTSi is due to a fiber cut and rerouted on a different length route), which would cause this component to experience a different transmission latency than before. This means that it is no longer phase aligned to the surviving components, makes the process of re-admitting it into the group in a hitless manner more difficult.

One approach to readmit the failed component could use typical deskew techniques such as immediately jumping/adjusting First-in-First-out (FIFO) read pointers, which causes a loss of data. Of course, a loss of data results in an undesirable traffic hit.

Accordingly, the present disclosure includes an approach to hitlessly readmit the failed component into a group. In particular, the approach described herein takes advantage of the fact that the failed components are being substituted with a replacement signal and performs the clock modification at this point in time, on the replacement signal, so it's the replacement signal and not the recovered components that are affected by the modified read clock rate. This is what allows for adjustment of the phase of the surviving components of traffic relative to recovered components in a hitless manner.

The hitless delay process includes clock adjustment that is performed on the traffic protocol (client) as a whole. This is because there can only be a single clock for a given client, using different clocks on pieces of a client would result in misalignment of the data and thus traffic corruption.

### Circuit

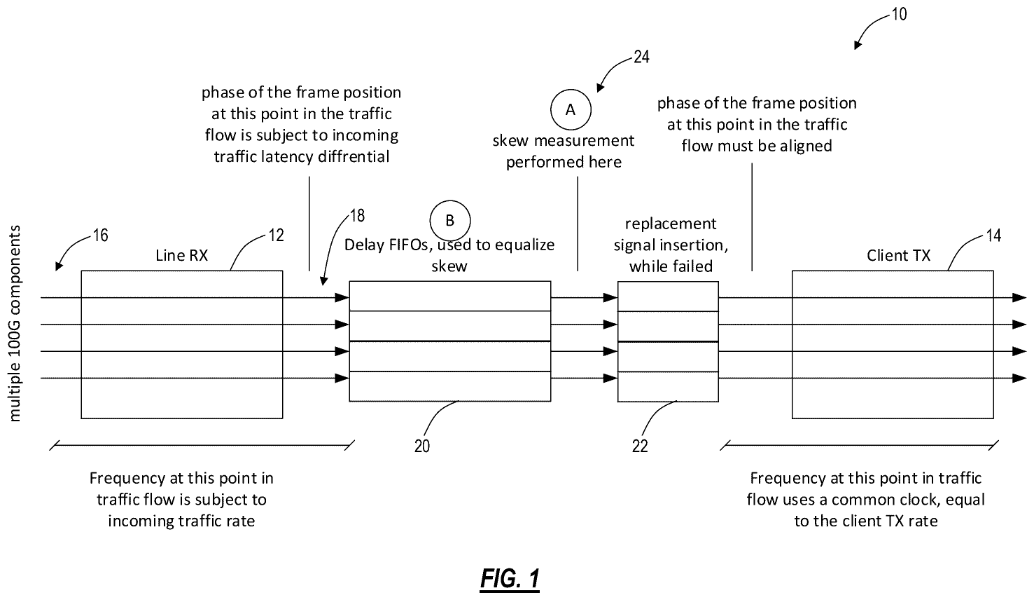

FIG. 1 is a block diagram of a circuit 10 for supporting hitless readmittance of recovered traffic to a group supporting partial survivability. In particular, the components in FIG. 1 are logical representations illustrating functionality in electrical circuitry, such as a Field Programmable Gate Array (FPGA), Application Specific Integrated Circuit (ASIC), Network Processing Unit (NPU), or the like. The circuit 10 can be used in a network element, network device, switch, router, transceiver, modem, transponder, or the like, namely any device that is involved in transmitting and receiving grouped traffic, such as at layer 1 (Time Division Multiplexing (TDM) and supported grouping of components. Again, OTN provides an example implementation with FlexO and OTUCn, and other approaches are also contemplated.

Also, the context of the circuit 10 is where the aggregate signal is received in a line receiver (Rx) 12, processed, and transmitted via a client transmitter (Tx) 14. Those skilled in the art will appreciate this shows one direction—from line Rx 12 to the client Tx 14. Of course, a bidirectional communication link will have the opposite direction as well, which is omitted for illustration purposes, but the same approach applies.

In FIG. 1, the present disclosure uses 100G components as an example to describe the hitless delay process that allows readmittance of one or more failed components into the aggregate, grouped signal in a hitless manner. Those skilled in the art will appreciate the same techniques apply for other values of the components. The key is the components are bonded together-frequency locked, and phase aligned in the aggregate signal.

In this example, there are four 100G components 16 received at the line Rx 12. At this point, the frequency of each of the four 100G components 16 are based on the incoming traffic rate, and the phase of the frame position in the traffic flow is subject to incoming traffic latency differential. That is, at the line Rx 12 and its output 18, the components 16 are not phase aligned.

Next, the circuit 10 includes delay FIFOs 20 which are used to equalize skew. The delay FIFOs 20 in electronic circuits are used to manage data synchronization and timing between the components 16 that operate at varying clock rates and/or have different latencies. To equalize skew, the delay FIFOs 20 can help align the components 16 that have been delayed or have traveled through paths in a network or different lengths in a circuit, ensuring that data arrives simultaneously or conforms to a specific timing requirement.

The delay FIFOs 20 temporarily store data entries as they enter and the FIFO structure ensures that the first piece of data to enter is also the first to exit, preserving the data order. The delay FIFO 20 can buffer data from one clock domain before passing it to another. This helps in managing timing differences and reducing the risk of data corruption. Skew refers to the timing discrepancies between multiple components intended to be phase aligned. With the components 16, even minor differences in path lengths or propagation delays can result in skew. The delay FIFO 20 can be configured to introduce a controllable delay to some of the signals, aligning them more closely with the slowest signal path.

The components 16 are phase and frequency aligned after the delay FIFOs 20 and provided to the client Tx 14. At the client Tx 14, the components 16 are bonded such that all traffic flows use a common clock equal to the client Tx 14 rate. Note, in an application, the components 16 are from different interfaces when received at the line Rx 12 and sent on a signal interface at the client Tx 14. For example, the four 100G components 16 can be received from four 100G interfaces, connected to the line Rx 12, and output a signal 400G connected to the client Tx 14. Of course, other applications are contemplated.

### Partial Survivability Via a Replacement Signal

Again, partial survivability is the concept that, when one of the components 16 fail, the remaining components 16 in the group can continue to carry traffic without also being affected by the failure. This may happen for example, in a mated pair application where parts of the traffic are carried over different wavelengths or different routes and one of these links fails.

The circuit 10 includes a block 22 between the delay FIFOs 20 and the client Tx 14, where the block 22 is configured to pass the components 16 that are phase and frequency aligned by the delay FIFOs 20 to the client Tx 14 and configured to insert a replacement signal when any one of the components 16 is failed, for partial survivability. The replacement signals are inserted such that their phase and frequency matches that of the surviving components.

It's not difficult to maintain the current frame position (which is synonymous to the phase of the traffic) and traffic rate of a failed component when a failure occurs by using the replacement signal.

Recovery after Partial Survivability

For illustration purposes, assume one of the components 16 fails and the other three survive, the failed component 16 being replaced by a replacement signal. Those skilled in the art will appreciate there can be various combinations of failed/survived components 16, and this situation of one out of four is merely presented to illustrate the concepts of the present disclosure.

When the failed component recovers, however, the frame position relative to the other components may have changed for various reasons, such as a change of route of the traffic, which would cause this component to experience a different transmission latency than before. This means that it is no longer phase aligned to the surviving components, makes the process of re-admitting it into the group in a hitless manner more difficult.

The present disclosure provides an approach to hitlessly re-admit any failed components 16 back into the group upon their recovery.

When a component recovers, the frequency will necessarily be the same as before. However, there are three situations that can occur with the phase. The frame position can either come back at the same place as it was when it failed, earlier in time than it was when it failed, or later in time that it was when it failed.

Before switching back to the recovered traffic for the failed component, the phase must be re-aligned to the other surviving components. In order to determine this, measurement of the relative skew between components 16 must be performed. This can be at the point 24 which measures the time the frame boundary occurs at for all components relative to a common reference (at location A in FIG. 1).

If the frame position returns to in exactly the same place as it was when it failed, recovery is straight forward since the block 22 can immediately switch to the recovered traffic, off of the replacement signal. If it's earlier in time than it was when it failed, recovery is also straight forward since the recovered component can be delayed by the difference in skew compared to the surviving components. Here, this delay can be achieved by using the delay FIFOs 20, which can be storage elements (at location B in FIG. 1).

When the skew of the recovered traffic is later in time than when failed, recovery is more complicated because the surviving components 16, which are carrying live traffic, are the ones that must be delayed in order for the group as a whole to again have zero skew between components 16. The approach described herein addresses this to ensure there is no traffic loss on the surviving components 16.

Hitlessly delaying the surviving components can be achieved through clock manipulation in the circuit 10. By slightly slowing down a read clock used for the surviving components 16, while the write rate is maintained, the amount of data stored in the delay FIFOs 20 will accumulate over time causing traffic to be delayed. Since bits are stored in the delay FIFOs 20, there is no loss of data associated with this approach. However, this process must be done slowly since it is common for downstream devices to generate their own read clock (synchronized to the incoming timing) with a Phase Lock Loop (PLL). Depending on its bandwidth, the PLL will only be able to react so fast to adjust for incoming timing changes. Performing too large of an adjustment too fast can therefore make downstream devices over/underflowing their own elastic storage elements.

During this process, the recovered traffic is still not used, its replacement signal is still sent downstream. This means that its delay is not modified by the read clock adjustment, allowing the surviving component's delay to be modified independently from the recovered traffic.

Once the surviving components 16 are equalized in skew, after the clock manipulation, the circuit 10 can switch the recovered traffic back into the group, in place of the replacement signal.

The hitless delay technique relies on clock manipulation to adjust the read rate compared to the write rate to modify the amount of data stored in the delay FIFO 20, and thus the delay experienced by the traffic. However, the entire client (i.e., group at the client Tx 14) is a single frequency, so normally this technique necessarily adjusts the delay of the entire client (including all of its components) at the same time, resulting in no relative skew change. Of note, the approach here is to use this technique only on the surviving components of the group, with the replacement signal, rather than the traffic as a whole which allows the relative skew of the recovered traffic compared to the surviving traffic to be adjusted.

### Process

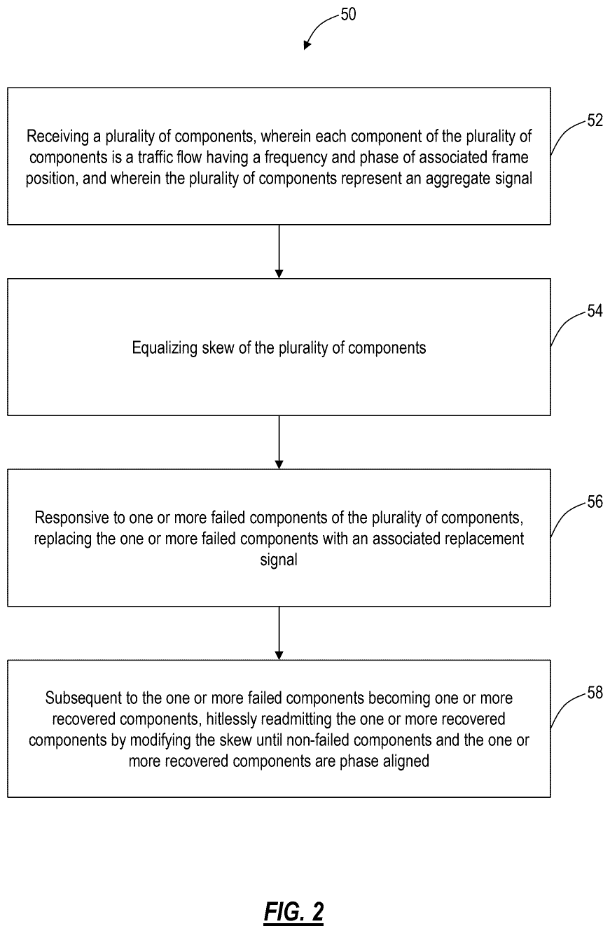

FIG. 2 is a flowchart of a process 50 for hitless readmittance of recovered traffic to a group supporting partial survivability. The process 50 contemplates implementation as a method having steps and via electric circuitry configuration to implement the steps. Further, the process 50 contemplates implementation in a network element, network device, switch, router, transceiver, modem, transponder, or the like, again any device that is involved in transmitting and receiving grouped traffic, such as at layer 1 (TDM) and supported grouping of components.

The process 50 includes receiving a plurality of components, wherein each component of the plurality of components is a traffic flow having a frequency and phase of associated frame position, and wherein the plurality of components represent an aggregate signal (step 52); equalizing skew of the plurality of components (step 54); responsive to one or more failed components of the plurality of components, replacing the one or more failed components with an associated replacement signal (step 56); and, subsequent to the one or more failed components becoming one or more recovered components, hitlessly readmitting the one or more recovered components by modifying the skew until non-failed components and the one or more recovered components are phase aligned (step 58).

The modifying the skew can include manipulating of a clock of the non-failed components, based on a skew of the one or more recovered components, and readmitting the one or more recovered components subsequent to the manipulation. The manipulating the clock can include slowing down a read clock used for the non-failed components, while maintaining a write clock as is. The one or more recovered components are hitlessly readmitted after equalizing the skew of the non-failed components with a skew of the one or more recovered components.

The process 50 can also include providing the non-failed components and the one or more recovered components, collectively second plurality of components, to a transmitter where the second plurality of components are phase and frequency aligned. The process 50 can also include causing transmission of the second plurality of components, by the transmitter, on one or more interfaces, wherein the second plurality of components are received from a second plurality of interfaces.

The one or more recovered components can be hitlessly readmitted based on measuring a skew of the one or more recovered components, and manipulating of a clock based on the measurement.

The one or more recovered components are hitlessly readmitted based on steps of readmitting the one or more recovered components with delay if the one or more recovered components have a frame position earlier in time than that of the non-failed components; readmitting the one or more recovered components as is if the one or more recovered components have the frame position at a same time as that of the non-failed components; and performing clock manipulation of the non-failed components to equalize the skew when the one or more recovered components have the frame position later in time.

The aggregate signal can be one of a Flexible Optical Transport Network (FlexO) signal and an Optical Transport Unit-Cn (OTUCn). The receiving can be via a plurality of Optical Tributary Signal (OTSi) carriers.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments. Also, in the claims, the terms “comprise,” “comprises,” “comprising,” “include,” “includes,” and “including” are intended to be non-limiting and open-ended. These terms specifically list essential elements or steps but do not exclude additional elements or steps. This applies even when a claim or series of claims includes more than one of these terms.

What is claimed is:

1. A circuit configured to:
receive a plurality of components, wherein each component of the plurality of components is a traffic flow having a frequency and phase of associated frame position, and wherein the plurality of components represent an aggregate signal,
equalize skew of the plurality of components,
responsive to one or more failed components of the plurality of components, replace the one or more failed components with an associated replacement signal, and
subsequent to the one or more failed components becoming one or more recovered components, hitlessly readmit the one or more recovered components by modifying the skew until non-failed components and the one or more recovered components are phase aligned.

2. The circuit of claim 1, wherein the modifying the skew includes
manipulation of a clock of the non-failed components, based on a skew of the one or more recovered components, and readmission of the one or more recovered components subsequent to the manipulation.

3. The circuit of claim 2, wherein the manipulation of the clock includes slowing down a read clock used for the non-failed components, while maintaining a write clock as is.

4. The circuit of claim 1, wherein the one or more recovered components are hitlessly readmitted after equalizing the skew of the non-failed components with a skew of the one or more recovered components.

5. The circuit of claim 1, wherein the circuit is further configured to
provide the non-failed components and the one or more recovered components, collectively second plurality of components, to a transmitter where the second plurality of components are phase and frequency aligned.

6. The circuit of claim 5, wherein the circuit is further configured to
cause transmission of the second plurality of components, by the transmitter, on one or more interfaces, wherein the second plurality of components are received from a second plurality of interfaces.

7. The circuit of claim 1, wherein the one or more recovered components are hitlessly readmitted based on
measurement of a skew of the one or more recovered components, and
manipulation of a clock based on the measurement.

8. The circuit of claim 1, wherein the one or more recovered components are hitlessly readmitted based on the circuit configured to perform one of
readmit the one or more recovered components with delay if the one or more recovered components have a frame position earlier in time than that of the non-failed components,
readmit the one or more recovered components as is if the one or more recovered components have the frame position at a same time as that of the non-failed components, and
perform clock manipulation of the non-failed components to equalize the skew when the one or more recovered components have the frame position later in time.

9. The circuit of claim 1, wherein the aggregate signal is one of a Flexible Optical Transport Network (FlexO) signal and an Optical Transport Unit-Cn (OTUCn).

10. The circuit of claim 1, wherein the receiving is via a plurality of Optical Tributary Signal (OTSi) carriers.

11. A method comprising steps of:
receiving a plurality of components, wherein each component of the plurality of components is a traffic flow having a frequency and phase of associated frame position, and wherein the plurality of components represent an aggregate signal;
equalizing skew of the plurality of components;
responsive to one or more failed components of the plurality of components, replacing the one or more failed components with an associated replacement signal; and
subsequent to the one or more failed components becoming one or more recovered components, hitlessly readmitting the one or more recovered components by modifying the skew until non-failed components and the one or more recovered components are phase aligned.

12. The method of claim 11, wherein the modifying the skew includes
manipulating of a clock of the non-failed components, based on a skew of the one or more recovered components, and readmitting the one or more recovered components subsequent to the manipulation.

13. The method of claim 12, wherein the manipulating the clock includes slowing down a read clock used for the non-failed components, while maintaining a write clock as is.

14. The method of claim 12, wherein the one or more recovered components are hitlessly readmitted after equalizing the skew of the non-failed components with a skew of the one or more recovered components.

15. The method of claim 12, wherein the steps further include
providing the non-failed components and the one or more recovered components, collectively second plurality of components, to a transmitter where the second plurality of components are phase and frequency aligned.

16. The method of claim 15, wherein the steps further include
causing transmission of the second plurality of components, by the transmitter, on one or more interfaces, wherein the second plurality of components are received from a second plurality of interfaces.

17. The method of claim 12, wherein the one or more recovered components are hitlessly readmitted based on
measuring a skew of the one or more recovered components, and
manipulating of a clock based on the measurement.

18. The method of claim 12, wherein the one or more recovered components are hitlessly readmitted based on steps of
readmitting the one or more recovered components with delay if the one or more recovered components have a frame position earlier in time than that of the non-failed components;
readmitting the one or more recovered components as is if the one or more recovered components have the frame position at a same time as that of the non-failed components; and
performing clock manipulation of the non-failed components to equalize the skew when the one or more recovered components have the frame position later in time.

19. The method of claim 12, wherein the aggregate signal is one of a Flexible Optical Transport Network (FlexO) signal and an Optical Transport Unit-Cn (OTUCn).

20. The method of claim 12, wherein the receiving is via a plurality of Optical Tributary Signal (OTSi) carriers.
